(19) United States
(12) Patent Application Publication
(10) Pub. No.: US 2023/0105176 A1
(43) Pub. Date: Apr. 6, 2023

(54) Efficient Federated Learning of Deep Neural Networks (DNNs) Using Approximation Layers

(71) Applicant: VMware, Inc., Palo Alto, CA (US)

(72) Inventors: Yaniv Ben-Itzhak, Herzliya (IL); Shay Vargaftik, Herzliya (IL); Nina Narodytska, Sunnyvale, CA (US); Mahmood Sharif, Herzliya (IL)

(21) Appl. No.: 17/492,457

(22) Filed: Oct. 1, 2021

(51) Int. Cl. G06N 3/08; G06K 9/62; H04L 29/08

(52) U.S. Cl. CPC G06N 3/08; G06K 9/6228; G06K 9/6256; H04L 67/10

(57) ABSTRACT

Techniques for implementing efficient federated learning of deep neural networks (DNNs) using approximation layers are provided. In one set of embodiments, given a DNN M with k original layers {L₁, . . . , Lₖ}, k approximation layers {L₁′, . . . , Lₖ′} can be created that correspond (i.e., map) to the k original layers. Each approximation layer can have the same number of inputs and outputs as its corresponding original layer, but can be smaller in size (i.e., have fewer parameters). Then, at the time of training DNN M via federated learning, for each participating client c during a training round r, a parameter server can transmit, for i=1, k, either (1) the current parameter values for approximation layer Lᵢ′ alone, or (2) the current parameter values for both original layer Lᵢ and approximation layer Lᵢ′ to client c. In response, client c can train its local copy of DNN M in accordance with the received parameter values.

### BACKGROUND

Federated learning is a machine learning (ML) technique in which multiple distributed clients—under the direction of a central entity known as a parameter server—collaboratively train an ML model using training datasets that reside locally on, and are private to, those clients. For example, in the scenario where the ML model is a deep neural network (DNN), federated learning typically involves (1) transmitting, by the parameter server, the DNN's current parameter values to the clients; (2) updating, by each client, a local copy of the DNN with the received parameter values; (3) forward propagating, by each client, a batch of training data instances through its local DNN copy; (4) computing, by each client based on the results of the forward propagation, gradient values for the DNN via backpropagation and transmitting the gradient values to the parameter server; (5) applying, by the parameter server, the gradient values received from the clients to update the DNN's parameter values; and (6) repeating steps (1) through (5) until a termination criterion is met.

Modern DNNs are often very large in size, with potentially hundreds of layers and hundreds of millions of parameters. Using federated learning to train such large DNNs poses several challenges, particularly in cases where the clients comprise edge devices that have limited hardware resources (e.g., smartphones, tablets, Internet-of-Things (IoT) devices, and the like). For example, high network bandwidth may be needed to communicate the DNN's parameter values and gradient values between the clients and the parameter server in a timely fashion, which may not be supported by clients with low power requirements or limited network connectivity. Further, the size of the DNN may exceed the amount of memory that the clients have available for the training process (or in some cases, may exceed their total memory capacity). Yet further, the clients may have insufficient compute resources to carry out the training calculations, or the overhead of those calculations may be unacceptable.

### BRIEF DESCRIPTION OF THE DRAWINGS

FIG. 1 depicts a system implementing conventional federated learning of a DNN.

FIG. 2 depicts an example neural network.

FIG. 3 depicts an example neural network with approximation layers according to certain embodiments.

FIG. 4 depicts a workflow for implementing efficient federated learning of a DNN using approximation layers according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### Overview

Embodiments of the present disclosure are directed to techniques for implementing efficient federated learning of DNNs by leveraging approximation layers. As used herein, an approximation layer is an alternative representation of an original layer of a DNN that has the same number of inputs and outputs as that original layer, but is smaller in size (i.e., has fewer parameters).

In one set of embodiments, given a DNN M with k original layers {L₁, . . . , Lₖ}, k approximation layers {L₁′, . . . , Lₖ′} can be created that correspond (i.e., map) to the k original layers. For example, approximation layer L₁′ can correspond to original layer L₁, approximation layer L₂^{′} can correspond to original layer L₂, and so on.

Then, for each federated learning training round r and for each client c participating in the training of DNN M during round r, the parameter server can transmit, for i=1, . . . , k, either (1) the current parameter values for approximation layer L₁′ alone, or (2) the current parameter values for both original layer Lᵢ and approximation layer Lᵢ′ to client c. In response, client c can train its local copy of DNN M in accordance with the received parameter values.

For example, if client c receives the current parameter values for approximation layer Lᵢ′ alone per option (1), client c can substitute original layer Lᵢ with approximation layer Lᵢ′ in its local copy of DNN M at the time of forward propagating training data instances through the local copy and computing its gradient values. However, if client c receives the current parameter values for both original layer Lᵢ and approximation layer Lᵢ′ per option (2), client c can keep original layer Lᵢ in its local copy of DNN M at the time of the forward propagation and gradient computation and can further compute a gradient for approximation layer Lᵢ′ based on the outputs of original layer Lᵢ. Finally, client c can return to the parameter server the computed gradient values for each original layer and corresponding approximation layer that c received during round r, and the parameter server can thereafter update the parameter values of DNN M based on the returned gradient values.

Because each approximation layer is smaller in size than its corresponding original layer, by choosing to send either the parameter values of the approximation layer alone or the parameter values of both the original layer and the approximation layer as explained above, the parameter server can control the amount of DNN parameter data that is communicated to the clients during each training round. This, in turn, can reduce the network, memory, and compute burden on the clients, thereby enabling resource-constrained edge devices to participate in the federated learning process. The foregoing and other aspects of the present disclosure are described in further detail below.

### Conventional Federated Learning and Solution Description

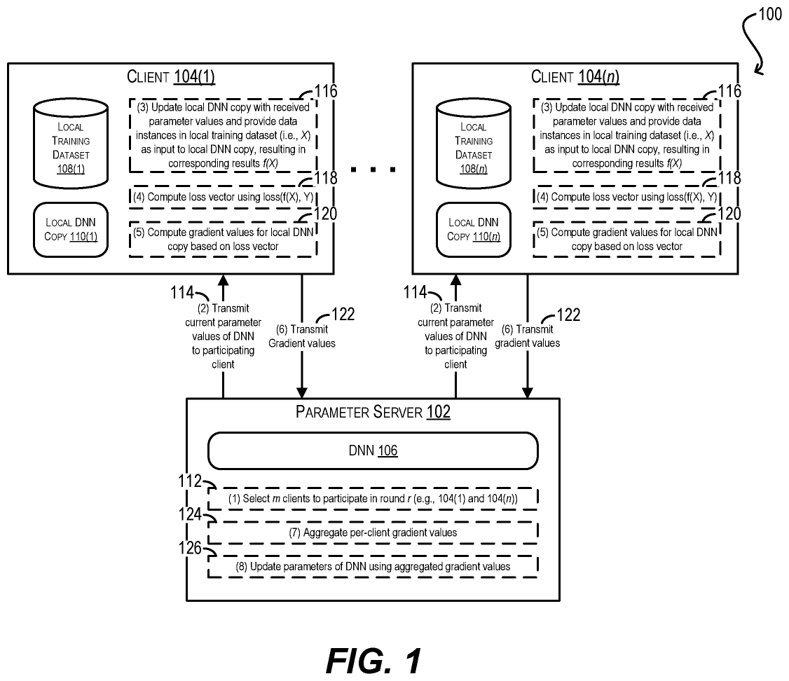

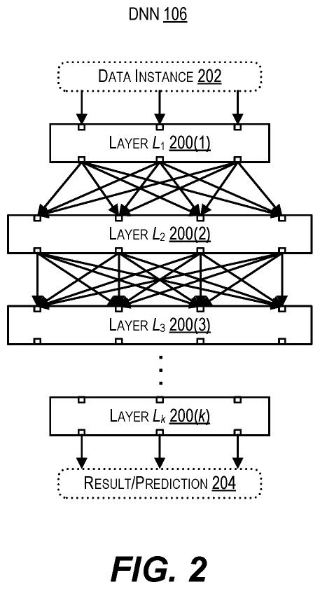

FIG. 1 depicts a system 100 comprising a parameter server 102 and a set of clients 104(1)-(n) that implement conventional federated learning of a DNN. A DNN is a type of ML model that includes a collection of nodes, also known as neurons, that are organized into layers and are interconnected via directed edges. For instance, FIG. 2 depicts an example representation of DNN 106 that includes k layers {L₁, . . . , Lₖ} (reference numerals 200(1)-(k)). Each layer Lᵢ is associated with parameters (e.g., weights and biases, not shown) that control how a data instance 202 (which is provided as input to the DNN via first layer 200(1)) is processed to generate a result/prediction 204 (which is output by final layer 200(k)). These parameters are the portions of the DNN that are adjusted via training in order to enable the DNN to generate accurate results/predictions.

Conventional federated learning proceeds according to a series of training rounds and FIG. 1 illustrates the steps performed by system 100 as part of a current training round r. Starting with steps (1) and (2) (reference numerals 112 and 114), parameter server 102 selects m clients to participate in round r and transmits parameter values for DNN 106 to each of the m (i.e., participating) clients. For ease of illustration, parameter server 102 transmits these parameter values to two clients 104(1) and 104(n) in FIG. 1, but in practice m can be any number between 1 and n. The parameter values transmitted at step (2) can include current values for all of the parameters of DNN 106 as determined via prior training rounds 1 to r−1.

At step (3) (reference numeral 116), each client 104(1)/104(n)—which maintains a local copy of DNN 106 (reference numeral 110(1)/110(n)) and a local training dataset 108(1)/108(n) that is private to that client—updates local DNN copy 110(1)/110(n) with the received parameter values and provides one or more data instances in its local training dataset 108(1)/108(n), collectively denoted by the matrix X, as input to local DNN copy 110(1)/110/(n). Each of these data instances comprises a set of attributes and a training label indicating a correct result that should be generated by the DNN upon receiving and processing the data instance's attributes. The outcome of step (3) is one or more results/predictions corresponding to input X, collectively denoted by f (X).

Each client 104(1)/104/(n) then computes a loss vector (sometimes referred to as an error) for X using a loss function that takes f (X) and the training labels of X (denoted by the vector Y) as input (step (4); reference numeral 118), uses backpropagation to compute gradient values for the entirety of local DNN copy 110(1)/110(n) based on the loss vector (step (5); reference numeral 120), and transmits the gradient values to parameter server 102 (step (6); reference numeral 122). Generally speaking, these gradient values indicate the degree to which the outputs of local DNN copy 110(1)/110(n) change in response to changes in the DNN's parameters in accordance with the computed loss vector.

At step (7) (reference numeral 124), parameter server 102 receives the gradient values from clients 104(1) and 104(n) and aggregates the per-client gradient values via averaging or some other aggregation operation. Finally, at step (8) (reference numeral 126), parameter server 102 employs an optimization technique to update the parameter values of DNN 106 based on the aggregated gradient values and current training round r ends. Steps (1)-(8) can subsequently repeat for additional rounds r+1, r+2, etc. until a termination criterion is met that ends the training of DNN 106. This termination criterion may be, e.g., an accuracy threshold or a number of training rounds threshold. Once the training of DNN 106 is complete, the trained version of DNN 106 can be provided to clients 104(1)-(n) to perform on-device inference (i.e., prediction) for unlabeled query data instances.

As noted in the Background section, in scenarios where DNN 106 is very large in size and clients 104(1)-(n) include edge devices with limited hardware resources, there are several challenges that can affect the feasibility of performing federated learning via the conventional procedure shown in FIG. 1. These challenges can include, e.g., memory, compute, and network bandwidth requirements that are beyond the capabilities or allowable limits of clients 104(1)-(n).

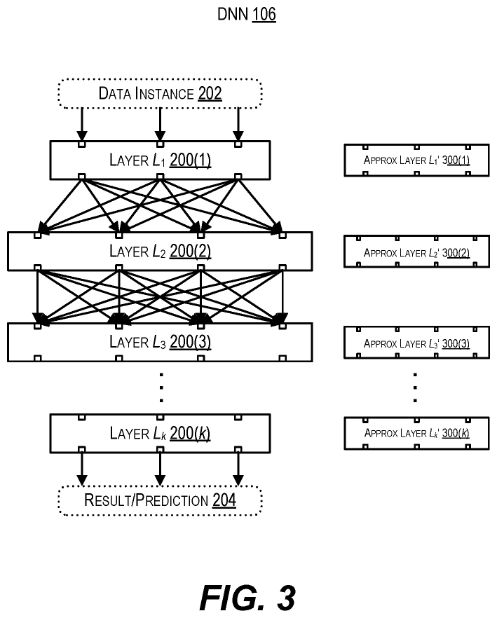

To address the foregoing, in various embodiments parameter server 102 and clients 104(1)-(n) can implement a more efficient federated learning process for training DNN 106 that involves the use of approximation layers. As mentioned previously, an approximation layer is an alternative representation of an original layer of a DNN that has the same number of input and outputs as the original layer, but is smaller in size and thus includes fewer trainable parameters. By way of example, FIG. 3 depicts the representation of DNN 106 from FIG. 2 that includes its original layers {L₁, . . . , Lₖ}, as well as approximation layers {L₁′, . . . , Lₖ′} (reference numerals 300(1)-(k)) which correspond to original layers {L₁, . . . , Lₖ} respectively. As shown in FIG. 3, each approximation layer Lᵢ′ accepts the same number of inputs and generates the same number of outputs as its corresponding original layer Lᵢ.

With these approximation layers for DNN 106 in place at parameter server 102 and clients 104(1)-(n), at the time of sending parameter values to each participating client 104 during a training round r, parameter server 102 can choose to send, for i=1, . . . , k, either (1) the parameter values for approximation layer Lᵢ′ alone, or (2) the parameter values for both original layer Lᵢ and approximation layer Lᵢ′. Parameter server 102 can make this selection based on various factors, such as the resource constraints present at the client and the importance of the original layer to the training outcome.

Each client 104 that receives the parameter values for both an original layer and its corresponding approximation layer per option (2) can train the two layers in parallel using its local training dataset and can transmit gradient values for those layers back to parameter server 102. Parameter server 102 can then aggregate the gradient values received from the various participating clients and can update the parameter values of DNN 106 accordingly.

With this general approach, parameter server 102 can regulate, on a per-layer basis, the amount of parameter data that is sent to and processed by clients 104(1)-(n), which advantageously allows for reduced resource overheads at each client without significantly impacting the overall effectiveness of the federated learning process. For example, parameter server 102 can carry out its distribution of per-layer parameter data to clients 104(1)-(n) in a manner that generally respects the resource constraints of each client, while at the same time ensuring that every original layer of DNN 106 receives an “adequate” amount of training (i.e., an amount that allows for quick training convergence and a relatively accurate trained model). A particular implementation of this approach in accordance with certain embodiments is detailed in section (3) below.

It should be appreciated that FIGS. 1-3 are illustrative and not intended to limit embodiments of the present disclosure. For example, although FIG. 3 suggests that every original layer Lᵢ of DNN 106 is mapped in a one-to-one fashion to an approximation layer Lᵢ′, in some cases not all original layers may be approximated, or a sequence of original layers may map to a single approximation layer.

Further, although parameter server 102 is depicted in FIG. 1 as a singular server/computer system, in some embodiments parameter server 102 may be implemented as a cluster of servers/computer systems for enhanced performance, reliability, and/or other reasons. One of ordinary skill in the art will recognize other variations, modifications, and alternatives.

Federated Learning Workflow Using Approximation Layers

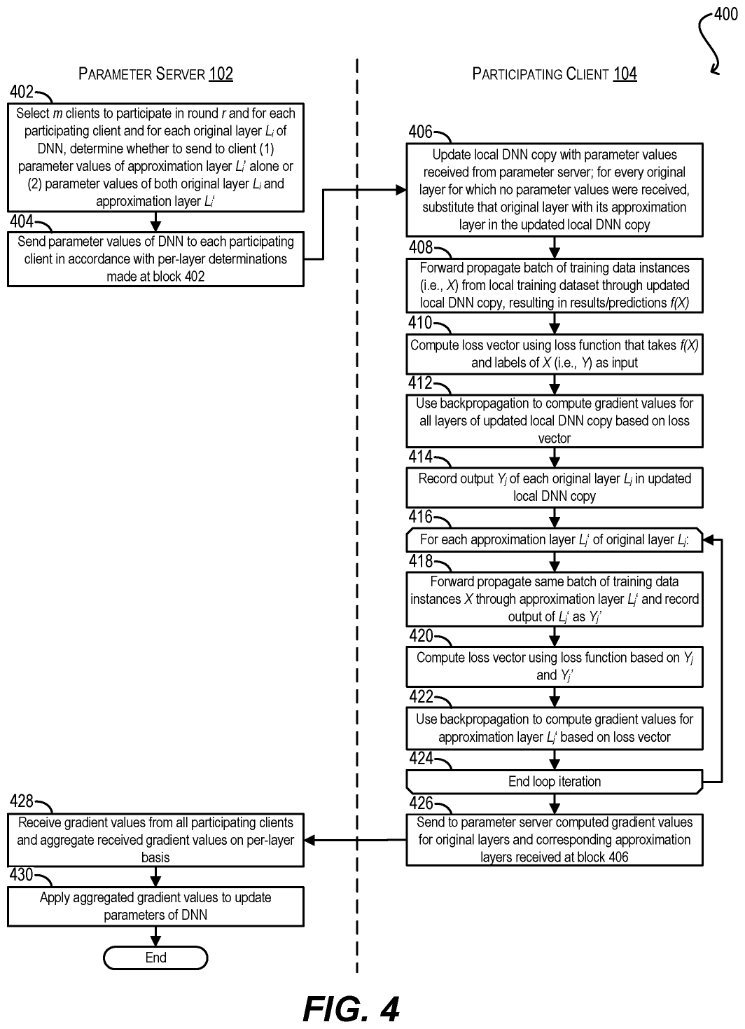

FIG. 4 depicts a workflow 400 that may be executed by parameter server 102 and clients 104(1)-(n) of FIG. 1 for implementing efficient federated learning of DNN 106 using approximation layers according to certain embodiments. The steps shown in workflow 400 pertain to the action executed by these entities in the context of a single training round r.

Workflow 400 assumes that parameter server 102 (or some other entity) has built approximation layers corresponding to the original layers of DNN 106 and has communicated the structure of DNN 106 (including both its original layers and its approximation layers) to clients 104(1)-(n) prior to the initiation of the federated learning process. The specific manner in which each approximation layer is built can differ depending on the nature and purpose of its corresponding original layer and the overall task that DNN 106 is intended to address. For example, if DNN 106 is intended to be used for image classification, it will typically include a number of convolutional layers, a number of batch normalization (BN) layers, and one or more activation layers. In this case, each convolutional layer can be approximated by a smaller/less complex approximation layer that includes a simplified set of parameters.

As indicated previously, in some embodiments one or more original layers of DNN 106 may have no corresponding approximation layer; such original layers will always be trained by every participating client in every training round. For instance, the first layer, the last layer, and the BN layers in an image classification DNN often play a large role in model accuracy and thus these specific layers may be excluded from being approximated. Further, a group of original layers, such as a sequence of repeated convolutional layers, may be approximated by a single approximation layer.

Starting with block 402 of workflow 400, parameter server 102 can select m clients to participate in round r and, for each participating client 104 and each original layer Lᵢ of DNN 106, determine whether to send to that client either (1) the parameter values of approximation layer Lᵢ′ alone or (2) the parameter values of both original layer Lᵢ and approximation layer Lᵢ′. Although not shown in the figure, in cases where original layer Lᵢ has no corresponding approximation layer (or in certain other scenarios), parameter server 102 may alternatively choose a third option (3) of sending to the client the parameter values of original layer Lᵢ alone. The determination at block 402 can be based on the compute, memory, and/or network bandwidth constraints at the client, as well as other factors such as the importance of each original layer to the training outcome. For example, if the client is subject to very strict resource constraints, parameter server 102 may choose option (2) or (3) for a few, very important original layers of DNN 106 and choose option (1) for all other layers, thereby substantially reducing the amount of parameter data that is sent to and processed by that client. The selection of option (3) over (2) for a very important layer can result in even further resource overhead savings at the client, at the cost of less updates for the corresponding approximation layer. One of ordinary of skill in the art will recognize other possible strategies and considerations.

In certain embodiments, parameter server 102 may undergo an initial negotiation process with each client that allows the parameter server to understand the client's resource limits. For instance, the client may inform parameter server 102 that it can accommodate a total DNN size of S gigabytes or P parameters, and the parameter server can thereafter perform its per-layer determinations at block 402 in accordance with those limits.

At block 404, parameter server 102 can send the parameter values of DNN 106 to each participating client 104 per the determinations made at block 402. In response, each participating client 104 can update its local copy of DNN 106 with the received parameter values (block 406). As part of block 406, for every original layer of DNN 106 for which the client did not receive parameter values per option (1), the client can substitute that original layer with its approximation layer in the local DNN copy. Conversely, for every original layer of DNN 106 for which the client received the parameter values of both the original layer and its approximation layer per option (2), the client can keep that original layer in the local DNN copy.

For example, assume DNN 106 includes a total of three original layers {L₁, L₂, L₃} and three approximation layers {L₁′, L₂′, L₃′} and the client received parameter values for (a) both original layer L₁ and approximation layer L₁′, (b) approximation layer L₂′ alone, and (c) both original layer L₃ and approximation layer L₃′. In this case, the client can update its local DNN copy to include layers {L₁, L₂′, L₃} along with their corresponding parameter values.

At block 408, the client can forward propagate a batch of training data instances (i.e., X) from its local training dataset through the updated local DNN copy, resulting in a set of results/predictions (i.e., f (X)). Note that the forward propagation of these training data instances will only pass through an approximation layer of DNN 106 if that approximation layer was sent by itself from parameter server 102, in accordance with updating of the local DNN copy performed at block 404.

The client can further compute a loss vector using a loss function that takes f (X) and Y (i.e., the labels of X) as input (block 410) and perform backpropagation through the updated local DNN copy to compute gradient values for all of its layers based on the loss vector (block 412). For instance, in the example above where the updated local DNN copy includes layers {L₁, L₂′, L₃}, the backpropagation performed at block 412 will result in gradient values for original layer L₁, approximation layer L₂′, and original layer L₃. The client can also record the direct outputs generated by each original layer Lⱼ in the updated local DNN copy (i.e., Yⱼ) as a result of the forward propagation of X at block 408 (block 414).

At block 416, the client can enter a loop for each approximation layer L₁′ corresponding to an original layer Lⱼ in the updated DNN copy (e.g., approximation layers L₁′ and L₃′ per the example above). Within this loop, the client can forward propagate the same batch of training data instances X used at block 408 through approximation layer Lⱼ′ (assuming that the remaining layers of the updated DNN copy stay the same) and can record the output of approximation layer Lⱼ′ as (block 418). The client can then compute a loss vector based on Yⱼ′ and Yⱼ (i.e., the previously-recorded outputs of original layer Lⱼ) (block 420) and perform backpropagation through approximation layer Lⱼ′ to compute gradient values for Lⱼ′ (block 422).

Upon completing the gradient computation at block 422, the client can reach the end of the current loop iteration (block 424) and return to the top of the loop to process any additional approximation layers Lⱼ′. The client can subsequently send the gradient values for the original layers that the client received from parameter server 102 (as computed at block 412) and their corresponding approximation layers (as computed at block 422) to the parameter server (block 426). For instance, in the prior example where the client received parameter values for (a) both original layer L₁ and approximation layer L₁′, (b) approximation layer L₂′ alone, and (c) both original layer L₃ and approximation layer L₃′, the client can send computed gradient values for L₁, L₁′, L₃, and L₃′ to parameter server 102 at block 426.

At block 428, parameter server 102 can receive gradient values from all m participating clients and aggregate the gradient values on a per-layer basis using some aggregation operation (e.g., averaging). Finally, parameter server 102 can apply the aggregated gradient values to DNN 106 in order to update the parameter values of its original layers and approximation layers (block 430). Current training round r can subsequently end, and additional training rounds (or in other words, additional executions of workflows 400) can be performed as needed until a termination criterion is satisfied.

It should be appreciated that workflow 400 is illustrative and various modifications are possible. For example, although workflow 400 assumes that each participating client does not change the parameter values of its updated local DNN copy after block 406, in some embodiments the client may, prior to entering the loop for each approximation layer Lⱼ′ at block 416, update the parameter values for their corresponding original layers Lⱼ based on the gradient values computed at block 412. This can potentially result in quicker and/or more accurate training of the approximation layers.

In addition, although workflow 400 indicates that each participating client does not provide gradient updates to parameter server 102 for approximation layers that were received by themselves (i.e., without corresponding original layer parameter data) per option (1) of block 402, in certain embodiments the client may also provide gradient values for these “unaccompanied” approximation layers—which are computed at block 412—to the parameter server. One of ordinary skill in the art will recognize other variations, modifications, and alternatives.

Efficient On-Device Inference Using Approximation Layers

Once the training of DNN 106 is completed via an appropriate number of iterations of workflow 400, parameter server 102 can provide the trained version of DNN 106 (comprising its trained original layers) to clients 104(1)-(n) to perform on-device inference for unlabeled query data instances. In some embodiments, as part of this step, parameter server 102 can also provide the trained approximation layers of DNN 106 to each client 104. This enables the client to substitute, at the time of on-device inference, one or more original layers of DNN 106 with their corresponding approximation layers in order to reduce the compute and memory overhead of the inference process.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
building, by a computer system, a set of approximation layers for a deep neural network (DNN), each approximation layer in the set of approximation layers corresponding to an original layer in a set of original layers of the DNN; and
at a time of training the DNN using federated learning:
selecting, by the computer system, a client to participate in a training round; and
for each original layer in the set of original layers, sending, by the computer system to the client, (1) parameter values of said each original layer and its corresponding approximation layer or (2) parameter values of said corresponding approximation layer alone.

2. The method of claim 1 wherein said each approximation layer has a same number of inputs and outputs as its corresponding original layer.

3. The method of claim 1 wherein said each approximation layer has a smaller number of parameters than its corresponding original layer.

4. The method of claim 1 wherein the computer system determines whether to send (1) or (2) based on one or more resource constraints of the client.

5. The method of claim 1 wherein the computer system determines whether to send (1) or (2) based on an importance of said each original layer to the training.

6. The method of claim 1 wherein upon receiving parameter values for a first original layer of the DNN and a corresponding first approximation layer of the first original layer, the client:
updates a local copy of the DNN in accordance with the received parameter values, the updated local copy including the first original layer;
forward propagates a batch of training data instances local to the client through the updated local copy, resulting in a set of predictions;
records a first set of outputs of the first original layer with respect to the forward propagation;
computes a first loss vector based on the set of predictions and labels for the batch of training data instances; and
computes first gradient values for the first original layer based on the first loss vector.

7. The method of claim 1 wherein the client further:
forward propagates the batch of training data instances through the first approximation layer, resulting in a second set of outputs;
computes a second loss vector based on the first set of outputs and the second set of outputs;
computes second gradient values for the first approximation layer based on the second loss vector; and
sends the first gradient values and the second gradient values to the computer system.

8. A non-transitory computer readable storage medium having stored thereon program code executable by a computer system, the program code causing the computer system to execute a method comprising:
building a set of approximation layers for a deep neural network (DNN), each approximation layer in the set of approximation layers corresponding to an original layer in a set of original layers of the DNN; and
at a time of training the DNN using federated learning:
selecting a client to participate in a training round; and
for each original layer in the set of original layers, sending to the client (1) parameter values of said each original layer and its corresponding approximation layer or (2) parameter values of said corresponding approximation layer alone.

9. The non-transitory computer readable storage medium of claim 8 wherein said each approximation layer has a same number of inputs and outputs as its corresponding original layer.

10. The non-transitory computer readable storage medium of claim 8 wherein said each approximation layer has a smaller number of parameters than its corresponding original layer.

11. The non-transitory computer readable storage medium of claim 8 wherein the computer system determines whether to send (1) or (2) based on one or more resource constraints of the client.

12. The non-transitory computer readable storage medium of claim 8 wherein the computer system determines whether to send (1) or (2) based on an importance of said each original layer to the training.

13. The non-transitory computer readable storage medium of claim 8 wherein upon receiving parameter values for a first original layer of the DNN and a corresponding first approximation layer of the first original layer, the client:
updates a local copy of the DNN in accordance with the received parameter values, the updated local copy including the first original layer;
forward propagates a batch of training data instances local to the client through the updated local copy, resulting in a set of predictions;
records a first set of outputs of the first original layer with respect to the forward propagation;
computes a first loss vector based on the set of predictions and labels for the batch of training data instances; and
computes first gradient values for the first original layer based on the first loss vector.

14. The non-transitory computer readable storage medium of claim 13 wherein the client further:
forward propagates the batch of training data instances through the first approximation layer, resulting in a second set of outputs;
computes a second loss vector based on the first set of outputs and the second set of outputs;
computes second gradient values for the first approximation layer based on the second loss vector; and
sends the first gradient values and the second gradient values to the computer system.

15. A computer system comprising:
a processor; and
a non-transitory computer readable medium having stored thereon program code that, when executed by the processor, causes the processor to:
build a set of approximation layers for a deep neural network (DNN), each approximation layer in the set of approximation layers corresponding to an original layer in a set of original layers of the DNN; and
at a time of training the DNN using federated learning:
select a client to participate in a training round; and
for each original layer in the set of original layers, send to the client (1) parameter values of said each original layer and its corresponding approximation layer or (2) parameter values of said corresponding approximation layer alone.

16. The computer system of claim 15 wherein said each approximation layer has a same number of inputs and outputs as its corresponding original layer.

17. The computer system of claim 15 wherein said each approximation layer has a smaller number of parameters than its corresponding original layer.

18. The computer system of claim 15 wherein the processor determines whether to send (1) or (2) based on one or more resource constraints of the client.

19. The computer system of claim 15 wherein the processor determines whether to send (1) or (2) based on an importance of said each original layer to the training.

20. The computer system of claim 15 wherein upon receiving parameter values for a first original layer of the DNN and a corresponding first approximation layer of the first original layer, the client:
updates a local copy of the DNN in accordance with the received parameter values, the updated local copy including the first original layer;
forward propagates a batch of training data instances local to the client through the updated local copy, resulting in a set of predictions;
records a first set of outputs of the first original layer with respect to the forward propagation;
computes a first loss vector based on the set of predictions and labels for the batch of training data instances; and
computes first gradient values for the first original layer based on the first loss vector.

21. The computer system of claim 20 wherein the client further:
forward propagates the batch of training data instances through the first approximation layer, resulting in a second set of outputs;
computes a second loss vector based on the first set of outputs and the second set of outputs;
computes second gradient values for the first approximation layer based on the second loss vector; and
sends the first gradient values and the second gradient values to the computer system.
